(19) United States
(12) Patent Application Publication
(10) Pub. No.: US 2013/0027384 A1
(43) Pub. Date: Jan. 31, 2013

(54) Method And Apparatus For Providing Vision Corrected Data At A Mobile Device

(71) Applicant: David M. Ferris, Southborough, MA (US)

(72) Inventor: David M. Ferris, Southborough, MA (US)

(21) Appl. No.: 13/557,970

(22) Filed: Jul. 25, 2012

Related U.S. Application Data
(60) Provisional application No. 61/512,033, filed on Jul. 27, 2011.

(51) Int. Cl. G02B 27/02; G09G 5/00

(52) U.S. Cl. 345/418; 359/642; 359/809

(57) ABSTRACT

A method, apparatus and computer program product for providing vision corrected data at a mobile device is presented. The data on the mobile device is provided accounting for vision correction requirements of a viewer of the information, such that the viewer does not require the use of corrective lenses to view the information on the display of the mobile device or the removal of corrective lenses to view the information.

Alternately a display cover, having a predefined shape, is provided that accounts for vision correction required by the user of the mobile device.

### CROSS REFERENCE TO RELATED APPLICATIONS

The present application claims the benefit of U.S. Provisional Patent Application No. 61/512,033, filed on Jul. 27, 2011, which is incorporated herein by reference in its entirety.

### BACKGROUND

The use of corrective lenses is ubiquitous. Corrective lenses, such eyeglasses, contact lenses and the like have become prevalent. Also prevalent is the use of mobile devices such as smart phones, tablets, Personal Digital Assistants (PDAs), laptop computers, and the like.

### SUMMARY

Conventional mechanisms such as those explained above suffer from a variety of deficiencies. One such deficiency is that for certain users of mobile devices, the data displayed on a mobile device may require the use of a corrective lenses (e.g., eyeglasses or contact lenses) when the user does not typically use for all activities (e.g. reading glasses) or the user may be required to remove corrective lenses currently being worn in order to view data on a mobile device display.

Embodiments of the invention significantly overcome such deficiencies and provide mechanisms and techniques that provide vision corrected data on a mobile device display. In a particular embodiment of a method for providing information on a display of a mobile device, the information on the mobile device is provided accounting for vision correction requirements of a viewer of the information, such that the viewer does not require the use of corrective lenses to view the information on the display of the mobile device.

Other embodiments include a computer readable medium having computer readable code thereon for providing vision corrected data on a mobile device display. The computer readable medium includes instructions for providing information on a display of a mobile device, the information provided accounting for vision correction requirements of a viewer of the information such that the viewer does not require the use of a corrective lenses to view the information on the display of the mobile device.

Still other embodiments include a display cover removably attachable to a display of a mobile device, the display cover having a predefined shape, wherein the predefined shape of the display cover provides vision correction such that a user of the mobile device is able to view information on the display of the mobile device without requiring to the viewer to wear corrective lenses to view the information on the mobile device or without requiring the user to remove corrective lenses to view the information on the mobile device.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a mobile device having a display cover for providing vision corrected data at a mobile device;

FIG. 2a is a side view of a first embodiment of a display cover for providing vision corrected data on a mobile device display in accordance with embodiments of the invention;

FIG. 2b is a side view of a second embodiment of a display cover for providing vision corrected data on a mobile device display in accordance with embodiments of the invention;

FIG. 3 is flow diagram of a particular embodiment of a method of providing vision corrected data at a mobile device; and

FIG. 4 illustrates an example mobile device architecture for a mobile device that provides vision corrected data in accordance with embodiments of the invention.

### DETAILED DESCRIPTION

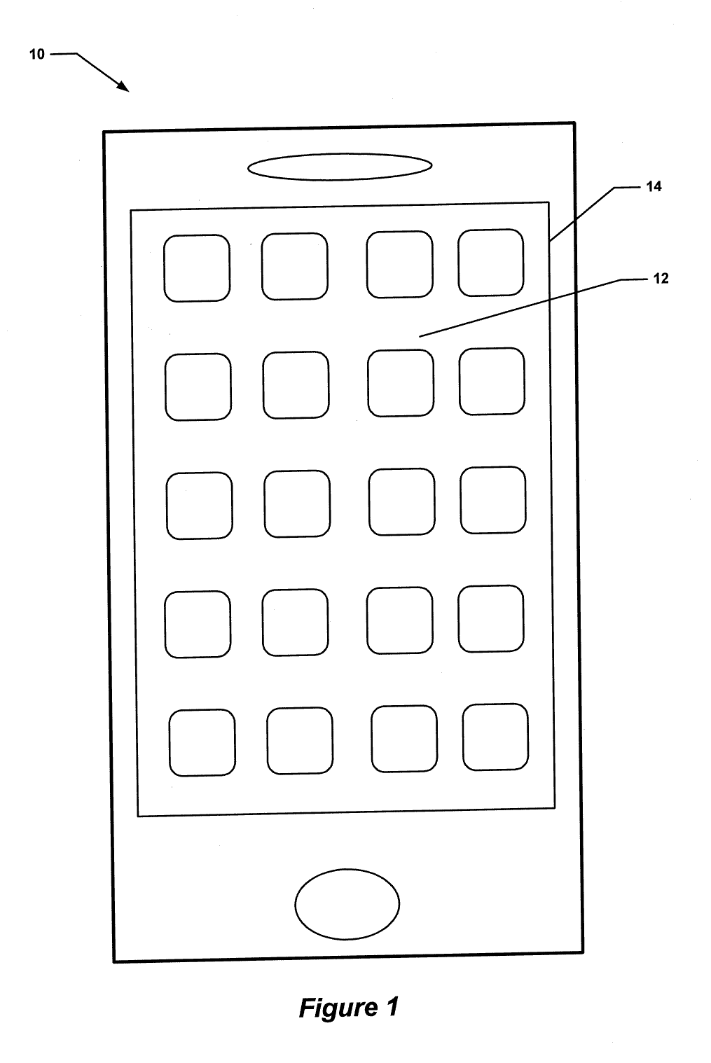

Referring now to FIG. 1, a mobile device 12 is shown. While in this description the mobile device is shown as a smart phone, it should be appreciated that the same concepts apply to other mobile devices, the mobile devices including but not limited to personal digital assistants (PDAs), handheld devices such as cellular telephones and the like, laptop computers, handheld computers and tablets. In this embodiment mobile device 10 includes a display cover 12 which is designed to provide vision corrected data on the mobile device display 14.

As an example, a person who is near-sighted may be required to wear corrective lenses (e.g., eye glasses or contact lenses). However when attempting to view small sized text on a mobile device, the user may be required to remove the eyeglasses or, in the case of a person wearing contact lenses, to hold the mobile device a distance away in order to read the information on the display of the mobile device. By way of the present invention, through use of either a display cover having a predefined shape or of a software application which runs on the mobile device, the person is able to view the information on the mobile device without having to remove their eyeglasses or hold the phone a distance away.

A similar situation arises with people who are far-sighted. For these people, they may need to wear eye glasses (commonly referred to as reading glasses) for reading information that is close to them. By way of the present invention, instead of the user having to put on a pair of glasses (or having to hold the phone very close to their eyes) they are able to view the display of the mobile device without the need of corrective lenses.

Referring to FIG. 1, a block diagram of an example mobile device 10 is shown. Mobile device 10 in this example is shown as a smart phone and includes a display 12.

Display 12 is used to render information to a user. As shown here, display 12 is showing a collection of icons for accessing different applications or functions of the mobile device 10. Mobile device 10 also has a display cover 14 installed covering display 12. Display cover 14 provides protection for the display to prevent scratching or marking of the display, and is typically made of a clear plastic material having a pre-defined thickness. In the present invention the display cover 14 additionally provides vision correction for a particular user of the mobile device 10.

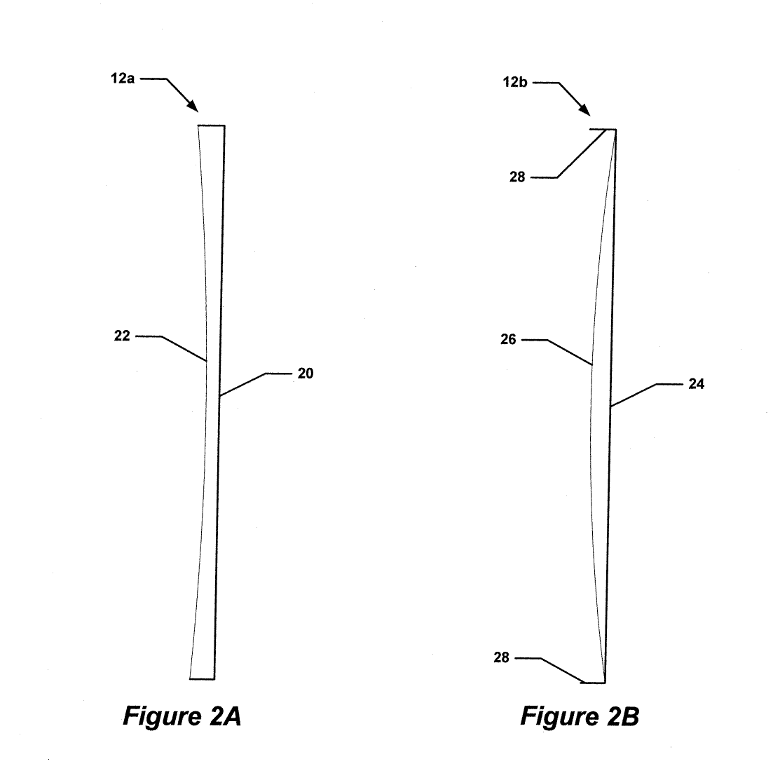

Referring now to FIGS. 2a and 2b, two different types of vision correction display covers are shown. FIG. 2a shows display cover 12a. Display cover 12a has a flat side 20 and a curved side 22, opposite flat side 20. The curved side 22 of display cover 12a provides a degree of vision correction for far-sighted people. The display cover 12a is installed onto a display of the mobile device with the curved side 22 facing the display and the flat side 20 facing the user.

FIG. 2b shows display cover 12b. Display cover 12b has a flat side 24 and a curved side 26, opposite flat side 24. The curved side 26 of display cover 12b provides a degree of vision correction for near-sighted people. The display cover 12b is installed onto a display of the mobile device with the curved side 26 facing the display and the flat side 24 facing the user. Display cover 12b also has a ridge 28 protruding outward defining a periphery of the display cover, and is used to keep the edges of flat side 24 from being placed in contact with the display of the mobile device.

In an alternate embodiment, an application is run on the mobile device that renders information on the display in a manner that provides for vision-corrected data. For example, the information on the display may be rendered in a larger format for far-sighted people or a smaller format for near sighted people. Other examples of rendering information in accordance with the present invention could include, but are not limited to, providing the information in a different color, in a different size, in a different font or with different spacing, or any other corrective adjustments that are required to allow the user to more easily view the display data.

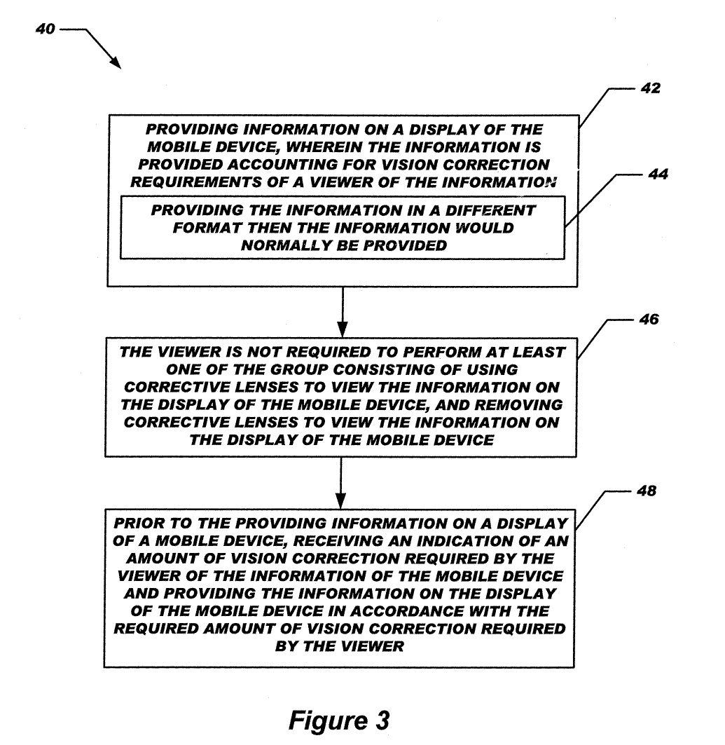

A flow diagram of particular embodiments of the presently disclosed method is depicted in FIG. 3. The rectangular elements are herein denoted “processing blocks” and represent instructions or groups of instructions. The flow diagram does not depict the syntax of any particular programming language. Rather, the flow diagram illustrates the functional information one of ordinary skill in the art requires to perform the processing required in accordance with the present invention. It should be noted that many routine elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Referring now to FIG. 3 a particular embodiment of a method 40 for providing vision corrected data at a mobile device is presented. Method 40 begins with processing block 42 which discloses providing information on a display of the mobile device, wherein the information is provided accounting for vision correction requirements of a viewer of the information. As shown in processing block 44, in a particular embodiment, the providing information on a display of the mobile device comprises providing the information in a different format then the information would normally be provided. For example, the information on the display may be rendered in a larger format for far-sighted people or a smaller format for near sighted people, or in a particular font which may be easier for the user to read. The information is provided taking into account corrective adjustments required by the user.

Processing block 46 states the viewer is not required to perform at least one of the group consisting of using corrective lenses to view the information on the display of the mobile device, and removing corrective lenses to view the information on the display of the mobile device.

Processing block 48 recites prior to the providing information on a display of a mobile device, receiving an indication of an amount of vision correction required by the viewer of the information of the mobile device and providing the information on the display of the mobile device in accordance with the required amount of vision correction required by the viewer.

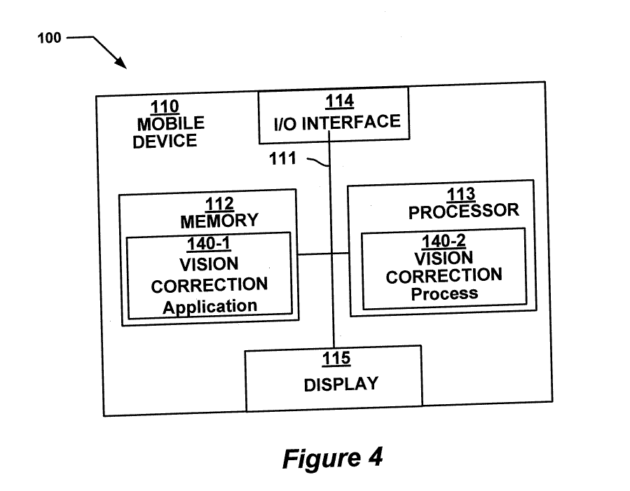

FIG. 4 is a block diagram illustrating example architecture of a mobile device 110 that executes, runs, interprets, operates or otherwise performs a vision correction operating application 140-1 and vision correction operating process 140-2 suitable for use in explaining example configurations disclosed herein. The mobile device 110 may be any type of computerized device such as a personal computer, workstation, portable computing device, console, laptop, network terminal or the like. As shown in this example, the mobile device 110 includes an interconnection mechanism 111 such as a data bus or other circuitry that couples a memory system 112, a processor 113, an input/output interface 114, and a display 115.

The memory system 112 is any type of computer readable medium, and in this example, is encoded with a vision correction operating application 140-1 as explained herein. The vision correction operating application 140-1 may be embodied as software code such as data and/or logic instructions (e.g., code stored in the memory or on another computer readable medium such as a removable disk) that supports processing functionality according to different embodiments described herein. During operation of the mobile device 110, the processor 113 accesses the memory system 112 via the interconnect 111 in order to launch, run, execute, interpret or otherwise perform the logic instructions of a vision correction operating application 140-1. Execution of a vision correction operating application 140-1 in this manner produces processing functionality in the vision correction operating process 140-2. In other words, the vision correction operating process 140-2 represents one or more portions or runtime instances of a vision correction operating application 140-1 (or the entire a vision correction operating application 140-1) performing or executing within or upon the processor 113 in the mobile device 110 at runtime. It should be appreciated that multiple applications can be provided on a single device, whereas one vision correction application is used by a first person (e.g., Mom who is near-sighted) and a second vision correction application is used by a second person (e.g., Dad who is far-sighted).

It is noted that example configurations disclosed herein include the vision correction operating application 140-1 itself (i.e., in the form of un-executed or non-performing logic instructions and/or data). The vision correction operating application 140-1 may be stored on a computer readable medium (such as a floppy disk), hard disk, electronic, magnetic, optical, or other computer readable medium. A vision correction operating application 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of a vision correction operating application 140-1 in the processor 113 as the vision correction operating process 140-2. Those skilled in the art will understand that the mobile device 110 may include other processes and/or software and hardware components, such as an operating system not shown in this example.

During operation, processor 113 of mobile device 110 accesses memory system 112 via the interconnect 111 in order to launch, run, execute, interpret or otherwise perform the logic instructions of the persistent security application 140-1. Execution of vision correction application 140-1 produces processing functionality in vision correction process 140-2. In other words, the vision correction process 140-2 represents one or more portions of the vision correction application 140-1 (or the entire application) performing within or upon the processor 113 in the mobile device 110.

It should be noted that, in addition to the vision correction process 140-2, embodiments herein include the vision correction application 140-1 itself (i.e., the un-executed or non-performing logic instructions and/or data). The vision correction application 140-1 can be stored on a computer readable medium such as a floppy disk, hard disk, or optical medium. The vision correction application 140-1 can also be stored in a memory type system such as in firmware, read only memory (ROM), or, as in this example, as executable code within the memory system 112 (e.g., within Random Access Memory or RAM).

In addition to these embodiments, it should also be noted that other embodiments herein include the execution of vision correction application 140-1 in processor 113 as the vision correction process 140-2. Those skilled in the art will understand that the mobile device 110 can include other processes and/or software and hardware components, such as an operating system that controls allocation and use of hardware resources associated with the mobile device 110.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the Internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A method in which a mobile device performs operations comprising:
providing information on a display of the mobile device, wherein said information is provided accounting for vision correction requirements of a viewer of said information; and
wherein said viewer is not required to perform at least one of the group consisting of using corrective lenses to view said information on said display of said mobile device, and removing corrective lenses to view said information on said display of said mobile device.

2. The method of claim 1 further comprising, prior to said providing information on a display of a mobile device, receiving an indication of an amount of vision correction required by said viewer of said information of said mobile device and providing said information on said display of said mobile device in accordance with said required amount of vision correction required by said viewer.

3. The method of claim 1 wherein said providing information on a display of the mobile device comprises providing said information in a different format then said information would normally be provided.

4. A non-transitory computer readable storage medium having computer readable code thereon for providing vision correction for a display of a mobile device, the medium including instructions in which a computer system performs operations comprising:
providing information on a display of the mobile device, wherein said information is provided accounting for vision correction requirements of a viewer of said information; and
wherein said viewer is not required to perform at least one of the group consisting of using corrective lenses to view said information on said display of said mobile device, and removing corrective lenses to view said information on said display of said mobile device.

5. The computer readable storage medium of claim 4 further comprising instructions for, prior to said providing information on a display of a mobile device, receiving an indication of an amount of vision correction required by said viewer of said information of said mobile device and providing said information on said display of said mobile device in accordance with said required amount of vision correction required by said viewer.

6. The computer readable storage medium of claim 4 further comprising instructions wherein said providing information on a display of the mobile device comprises providing said information in a different format then said information would normally be provided.

7. A mobile device comprising:
a memory;
a processor;
a communications interface;
an interconnection mechanism coupling the memory, the processor and the communications interface; and
wherein the memory is encoded with an application providing vision corrected data, that when performed on the processor, provides a process for processing information, the process causing the computer system to perform the operations of:
providing information on a display of the mobile device, wherein said information is provided accounting for vision correction requirements of a viewer of said information; and
wherein said viewer is not required to perform at least one of the group consisting of using corrective lenses to view said information on said display of said mobile device, and removing corrective lenses to view said information on said display of said mobile device.

8. The mobile device of claim 7 wherein, prior to said providing information on a display of a mobile device, receiving an indication of an amount of vision correction required by said viewer of said information of said mobile device and providing said information on said display of said mobile device in accordance with said required amount of vision correction required by said viewer.

9. The mobile device of claim 7 wherein said providing information on a display of the mobile device comprises providing said information in a different format then said information would normally be provided.

10. An apparatus comprising:
a display cover attachable to a display of a mobile device, said display cover having a predefined shape, wherein said predefined shape of said display cover provides vision correction for a viewer, wherein said viewer is not required to perform at least one of the group consisting of using corrective lenses to view said information on said display of said mobile device, and removing corrective lenses to view said information on said display of said mobile device.

11. The apparatus of claim 10 wherein said display cover has a convex surface on one side thereof shape for providing said information on said display of said mobile device in accordance with an amount of vision correction required by said viewer.

12. The apparatus of claim 11 wherein said display cover is installed on said display of said mobile device wherein said convex surface is facing said display.

13. The apparatus of claim 10 wherein said display cover has a concave surface on one side thereof for providing said information on said display of said mobile device in accordance with an amount of vision correction required by said viewer.

14. The apparatus of claim 13 wherein said display cover is installed on said display of said mobile device wherein said concave surface is facing said display.

15. The apparatus of claim 13 wherein said display cover further comprises a raised ridge about at least a portion of a periphery of said display cover.

16. The apparatus of claim 10 wherein said cover is removably attachable to said mobile device.
